(19) United States
(12) Patent Application Publication
(10) Pub. No.: US 2016/0168799 A1
(43) Pub. Date: Jun. 16, 2016

(54) PAPER CUP COMPRISING A POLYETHYLENE COPOLYMER COATING AND METHODS OF MAKING THE SAME

(71) Applicant: BASF SE, Ludwigshafen (DE)

(72) Inventor: David R. Constant, Charlotte, NC (US)

(21) Appl. No.: 14/909,950

(22) PCT Filed: Jul. 8, 2014
(86) PCT No.: PCT/US2014/045773

§ 371 Date: Feb. 3, 2016

Related U.S. Application Data
(60) Provisional application No. 61/862,342, filed on Aug. 5, 2013.

(51) Int. Cl. D21H 21/18; B65D 3/06; D21H 19/82; B31B 1/00; D21H 19/22; D21H 19/64

(52) U.S. Cl. CPC D21H 21/18; D21H 19/22; D21H 19/64; D21H 19/82; B31B 1/00; B65D 3/06; B31B 2201/62; B31B 2203/062; B31B 2203/064

(57) ABSTRACT

The present disclosure relates to a paper cup comprising a first coating comprising a polyethylene copolymer on a first surface of the paper cup and optionally a second aqueous-based coating on a second surface of the paper cup. In some embodiments, the first coating is on an inside surface of a bottom portion of the paper cup, and the second aqueous-based coating is on an inside of a side portion of the paper cup. The present disclosure also relates to methods of making the paper cups disclosed herein.

### FIELD OF THE DISCLOSURE

The present disclosure relates to a paper cup comprising a first coating comprising a polyethylene copolymer on a first surface of the paper cup and optionally a second aqueous-based coating comprising on a second surface of the paper cup. The present disclosure also relates to methods of making the disclosed paper cups.

### BACKGROUND

Various methods have been used to prevent liquid leakage in paper cups, including providing low-density polyethylene homopolymer coatings on the interior of the paper cups to make the cups waterproof. There has been an industry focus on providing aqueous-based coatings as a method of reducing the polyethylene coatings in paper cups. However, additional improvement is needed with these aqueous-based coatings, for instance, in terms of heat-seal and holding hot liquids without leakage. Accordingly, a paper cup with a reduced amount of polyethylene that still provides adequate heat seal and that can hold hot liquids without leakage or staining is desirable.

### SUMMARY OF THE DISCLOSURE

Disclosed herein are paper cups comprising a paper cup having a side portion and a bottom portion, a first coating comprising a polyethylene copolymer on a first surface of the paper cup, the first surface comprising one or more of an interior surface of the side portion or an interior surface of the bottom portion, wherein a bottom edge of the side portion is bonded to a side edge of the bottom portion via a seal comprising the first coating. In some embodiments, the polyethylene copolymer has polar functionality. In some embodiments, the polyethylene copolymer has a melting point temperature of 95° C. to 105° C. In some embodiments, the polyethylene copolymer has a Vicat softening temperature of 50° C. to 90° C. In some embodiments, the polyethylene copolymer has a density of 0.65 g/cm³ to 1.1 g/cm³. In some embodiments, the first coating has a thickness of 0.5 mils to 2 mils. In some embodiments, the first coating has a coating weight of 10 g/m² to 25 g/m².

The paper cups disclosed herein can also comprise a second aqueous-based coating on a second surface of the paper cup, the second surface comprising an interior surface of the bottom portion of the cup when the first surface is the interior surface of the side portion and the second surface comprising an interior surface of the side portion of the cup when the first surface is the interior surface of the bottom portion, wherein a bottom edge of the side portion is bonded to a side edge of the bottom portion via a seal comprising the first coating and the second aqueous-based coating. In some embodiments, the second aqueous-based coating further comprises a pigment that has been treated with a material selected from the group consisting of surfactants; hydrophobically-modified polymers; styrene-acrylic resin emulsions; styrene-butadiene latex emulsions; silanes, siloxanes, siloxane/silicone resin blends, and their carbon-based analogs; and combinations thereof.

In some embodiments, the first surface comprises an interior surface of the bottom portion of the paper cup. In some embodiments, the first surface comprises the interior surface of the side portion of the paper cup. In some embodiments, the side portion of the paper cup is adhered to itself along a side edge. In some embodiments, the second surface is the inside surface of the side portion, and the treated pigment has been treated with a styrene-acrylic resin emulsion. In some embodiments, the paper cup does not exhibit a leak along the seal of the paper cup for thirty minutes after substantially filling the cup with hot coffee at a temperature of 90° C.

Also disclosed herein are methods of producing a paper cup, forming a side wall or a bottom from a first paper substrate, at least a portion of a surface of the first paper substrate coated with a first coating comprising a polyethylene copolymer, wherein the polyethylene copolymer has polar functionality, bonding the side wall to itself along a side edge, and bonding the side wall along a bottom edge to the bottom along a side edge to form a seal comprising the first coating. In some embodiments, the first coating is coated onto the first paper substrate by extrusion coating.

In some embodiments, the method further comprises a second paper substrate, wherein at least a portion of the second paper substrate is coated with the polyethylene copolymer and the second paper substrate is formed into a side wall if the first substrate is formed into a bottom and the second paper substrate is formed into a bottom if the first substrate is formed into a side wall.

In some embodiments, the method further comprises a second paper substrate, wherein at least a portion of the second paper substrate is coated with an aqueous-based coating and the second paper substrate is formed into a side wall if the first substrate is formed into a bottom and the second paper substrate is formed into a bottom if the first substrate is formed into a side wall.

In some embodiments, the first paper substrate is the bottom and the second paper substrate is the side wall.

The details of one or more embodiments are set forth in the description below. Other features, objects, and advantages will be apparent from the description and from the claims.

### DETAILED DESCRIPTION

The present disclosure relates to a paper cup comprising a first coating comprising a polyethylene copolymer on a first surface of the paper cup and optionally a second aqueous-based coating on a second surface of the paper cup. The present disclosure also relates to methods of making the disclosed paper cups.

The paper cup can comprise any paper capable of being coated with a polyethylene copolymer and/or an aqueous-based coating and then formed into a paper cup. The paper can comprise cellulose fibers and/or additional fibers such as polymeric fibers. In some embodiments, the paper cup comprises 50% by weight or greater (e.g., 55% or greater, 60% or greater, 65% or greater, 70% or greater, 75% or greater, 80% or greater, 85% or greater, 90% or greater, or 95% or greater) of fibers. In some embodiments, the paper cup comprises paper, paper board, or cardboard. The paper cup can comprise recycled paper. The paper can be any weight suitable for use in a paper cup (e.g., 13 point or 18 point).

The paper comprises a first coating comprising a polyethylene copolymer on a first surface of the paper cup. In some embodiments, the polyethylene copolymer has polar functionality (i.e., has been modified to include a functional monomer so that the polarity of the polyethylene copolymer is greater than the polarity of polyethylene homopolymer). The first coating can comprise a polyethylene copolymer prepared by polymerizing an ethylene monomer and an acrylic monomer. The acrylic monomer can be selected from methacrylic acid, methyl acrylate, or a combination thereof. Methods of preparing these copolymers are known in the art and they can be prepared, for example, using coordination or radical polymerization. In some embodiments, the acrylic monomer is present in an amount of 3% or greater (e.g., 4% or greater, 5% or greater, 6% or greater, 7% or greater, 8% or greater, 9% or greater, 10% or greater, 11% or greater, 12% or greater, 13% or greater, 14% or greater, 15% or greater, 16% or greater, 17% or greater, 18% or greater, 19% or greater) by weight of the polyethylene copolymer. In some embodiments, the acrylic monomer is present in an amount of 20% or less (e.g., 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, or 4% or less) by weight of the polyethylene copolymer. In some embodiments, the acrylic monomer is present in an amount of from 3% to 20% (e.g., 4% to 15%, 6% to 12%) by weight of the polyethylene copolymer.

In some embodiments, the polyethylene copolymer has a density of 0.65 g/cm³ or greater (e.g., 0.7 g/cm³ or greater, 0.75 g/cm³ or greater, 0.8 g/cm³ or greater, 0.85 g/cm³ or greater, or 0.9 g/cm³ or greater), as measured by ASTM D792 (2008). In some embodiments, the polyethylene copolymer has a density of 1.1 g/cm³ or less (e.g., 1.05 g/cm³ or less, 1.0 g/cm³ or less, 0.95 g/cm³ or less, 0.90 g/cm³ or less, 0.85 g/cm³ or less, or 0.8 g/cm³ or less), as measured by ASTM D792 (2008). In some embodiments, the polyethylene copolymer has a density of from 0.65 g/cm³ to 1.1 g/cm³ (e.g., from 0.7 g/cm³ to 1.0 g/cm³, from 0.75 g/cm³ to 0.95 g/cm³, from 0.8 g/cm³ to 0.9 g/cm³), as measured by ASTM D792 (2008).

The polyethylene copolymer has, in some embodiments, a melt flow rate of 4 g/10 min or greater (e.g., 5 g/10 min or greater, 6 g/10 min or greater, 7 g/10 min or greater, 8 g/10 min or greater, 9 g/10 min or greater, 10 g/10 min or greater, 11 g/10 min or greater, 12 g/10 min or greater, or 13 g/10 min or greater) as measured by ASTM D1238 (2010). The polyethylene copolymer has, in some embodiments, a melt flow rate of 14 g/10 min or less (e.g., 13 g/10 min or less, 12 g/10 min or less, 11 g/10 min or less, 10 g/10 min or less, 9 g/10 min or less, 8 g/10 min or less, 7 g/10 min or less, 6 g/10 min or less, 5 g/10 min or less) as measured by ASTM D1238 (2010).

In some embodiments, the polyethylene copolymer has a melting point temperature (DSC) of greater than 100° C. (e.g., greater than 100.5° C., greater than 101° C., greater than 101.5° C., greater than 102° C., greater than 102.5° C., greater than 103° C., greater than 103.5° C., greater than 104° C., greater than 104.5° C., greater than 105° C., greater than 110° C., greater than 115° C., or greater than 120° C.), as measured by ASTM D3418 (2012-e1). In some embodiments, the polyethylene copolymer has a melting point temperature (DSC) of less than 110° C. (e.g., less than 109° C., less than 108° C., less than 107° C., less than 106° C., less than 105° C., less than 104° C., less than 103° C., less than 102.5° C., less than 102° C., less than 101.5° C., less than 101° C.), as measured by ASTM D3418 (2012-e1). In some embodiments, the polyethylene copolymer has a melting point temperature (DSC) of from 100° C. to 110° C. (e.g., 101° C. to 106° C., 101° C. to 104° C.), as measured by ASTM D3418 (2012-e1).

In some embodiments, the polyethylene copolymer has a Vicat softening point of 60° C. or greater (e.g., 65° C. or greater, 70° C. or greater, 75° C. or greater, 80° C. or greater, or 85° C. or greater) as measured by ASTM D1525 (2009). In some embodiments, the polyethylene copolymer has a Vicat softening point of 95° C. or less (e.g., 90° C. or less, 85° C. or less, 80° C. or less, 75° C. or less, 70° C. or less, or 65° C. or less) as measured by ASTM D1525(2009). In some embodiments, the polyethylene copolymer has a Vicat softening point of from 60° C. to 95° C. (e.g., 65° C. to 93° C., from 68° C. to 90° C.) as measured by ASTM D1525 (2009).

The paper cup can comprise one or more types of coatings (e.g., two types of coatings, three types of coatings, or four types of coatings). In some embodiments, the paper cup comprises a layer of an aqueous-based polymer coating applied onto a layer of the polyethylene copolymer coating. In some embodiments, the paper cup comprises a layer of the polyethylene copolymer coating applied onto an aqueous-based polymer coating. In some embodiments, the paper cup comprises an aqueous-based polymer coating and/or a polyethylene copolymer coating and an additional coating. The first coating has a thickness of from 0.5 mils or greater (e.g., 0.6 mils or greater, 0.7 mils or greater, 0.8 mils or greater, 0.9 mils or greater, 1 mil or greater, 1.1 or greater, 1.2 or greater, 1.3 or greater, 1.4 or greater, 1.5 or greater, 1.6 or greater, 1.7 or greater, 1.8 or greater, 1.9 or greater). In some embodiments, the first coating has a thickness of 2 mils or less (e.g., 1.9 or less, 1.8 or less, 1.7 or less, 1.6 or less, 1.5 or less, 1.4 or less, 1.3 or less, 1.2 or less, 1 or less, 0.9 or less, 0.8 or less, 0.7 or less, or 0.6 or less). In some embodiments, the polyethylene copolymer coating has a thickness of from 0.5 mils to 2 mils (e.g., from 0.9 mils to 1.6 mils, from 1.1 mils to 1.4 mils). The coating thickness can be calculated based on the density of the coating and the weight of the coated paper.

In some embodiments, the first coating has a coating weight of 10 g/m² or greater (e.g., 11 g/m² or greater, 12 g/m² or greater, 13 g/m² or greater, 14 g/m² or greater, 15 g/m² or greater, 16 g/m² or greater, 17 g/m² or greater, 18 g/m² or greater, 19 g/m² or greater, 20 g/m² or greater, 21 g/m² or greater, 22 g/m² or greater, 23 g/m² or greater, or 24 g/m² or greater). In some embodiments, the first coating has a coating weight of 25 g/m² or less (e.g., 24 g/m² or less, 23 g/m² or less, 22 g/m² or less, 21 g/m² or less, 20 g/m² or less, 19 g/m² or less, 18 g/m² or less, 17 g/m² or less, 16 g/m² or less, 15 g/m² or less, 14 g/m² or less, 13 g/m² or less, 12 g/m² or less, 11 g/m² or less). In some embodiments, the first coating has a coating weight of from 10g/m² to 25 g/m² (e.g., 15 g/m² to 23 g/m² or 18 g/m² to 22 g/m²). The coating weight can be described in units of grams of coating per square meter of paper, and can be calculated directly by the amount of coating applied and the surface area of the paper substrate that the coating is applied to. In some embodiments, the first coating can be applied in an amount of less than 15% by weight based on the weight of the coated paper.

The first coating can be coated onto a paper substrate using a melt extrusion process. In some embodiments, the first coating can be coated onto the paper substrate at a melt extrusion temperature of 185° C. or greater (e.g., 190° C. or greater, 200° C. or greater, 210° C. or greater, 220° C. or greater, 230° C. or greater, 240° C. or greater, 250° C. or greater, 260° C. or greater, 270° C. or greater, 280° C. or greater, 290° C. or greater, 300° C. or greater, or 310° C. or greater). The melt extrusion temperature can be 320° C. or less (e.g., 315° C. or less, 310° C. or less, 300° C. or less, 290° C. or less, 280° C. or less, 270° C. or less, 260° C. or less, 250° C. or less, 240° C. or less, 230° C. or less, 220° C. or less, 210° C. or less, 200° C. or less, or 190° C. or less). The melt extrusion temperature of the first coating can be between 185° C. and 325° C. (e.g., from 215° C. to 320° C. or 235° C. to 315° C.).

The paper cup can also comprise a second aqueous-based coating. The aqueous-based coating can comprise an aqueous-based polymer. The aqueous-based polymer can be water-soluble and/or water-dispersible. In some embodiments, the second aqueous-based coating is a coating described in U.S. Patent Application Publication No. 2011/0046284, which is incorporated herein by reference in its entirety. For instance, the second aqueous-based coating can include a pigment having at least one of the following desired attributes:
acceptable morphology appropriate to a given application;
controlled surface area, engineered morphology particles;
ultrafine size particles;
highly porous particles having pore size distribution and surface area tailored to the target barrier coating application; and
high surface area particles.

The pigment can also undergo a thermal treatment process and then, with or without the thermal treatment, can be treated with a material that will facilitate repulsion of water and/or significantly slow the rate of diffusion of the target species (high surface tension or contact angle). The pigments can be treated with materials that may include, but are not limited to:
surfactants such as stearates;
hydrophobically modified polymers such as polyethylenimine (PEI);
styrene-acrylic resin emulsion chemistries;
styrene-butadiene latex chemistries;
silanes, siloxanes, siloxane/silicon resin blends, and their carbon-based analogs; and
combinations thereof.

In some embodiments, the pigment can be treated with a copolymer such as a styrene acrylic copolymer derived from monomers including styrene, (meth)acrylic acid, (meth)acrylic acid esters, (meth)acrylamide, (meth)acrylonitrile, and mixtures thereof. For example, the styrene acrylic copolymer can include styrene and at least one of (meth)acrylic acid, itaconic acid, methyl (meth)acrylate, ethyl (meth)acrylate, n-butyl (meth)acrylate, isobutyl (meth)acrylate, tert-butyl (meth)acrylate, 2-ethylhexyl (meth)acrylate, (meth)acrylamide, (meth)acrylonitrile, and hydroxyethyl (meth)acrylate.

In some embodiments, the pigment can be treated with a styrene-butadiene copolymer derived from monomers including styrene, butadiene, (meth)acrylamide, (meth)acrylonitrile, itaconic acid and (meth)acrylic acid. The styrene butadiene copolymer can also include from 0 to 3 phm of one or more crosslinking monomers such as divinylbenzene.

The pigment system can be a stable slurry that can contain any of the combination of pigments described above as well as a dispersant, an optional defoamer and a thickener. The dispersant can be a latex, starch or polyvinyl alcohol (PVAL). Natural thickening aids such as starch or protein or synthetic polymers such as Sterocoll FS (available from BASF Corporation) can be used to thicken/stabilize the pigment system. The barrier coating formulation consists of the pigment system, an optional defoamer/de-aeration/antifoam agent, a cross linker (glyoxal or AZC for example), and a binder. The binder is can be a styrene acrylic resin emulsion (SA), a styrene butadiene latex (SB latex), PVAL, starch, protein and a combination thereof, which can also contribute to the barrier properties.

In some embodiments, the second aqueous-based coating has a coating weight of 10 g/m² or greater (e.g., 11 g/m² or greater, 12 g/m² or greater, 13 g/m² or greater, 14 g/m² or greater, 15 g/m² or greater, 16 g/m² or greater, 17 g/m² or greater, 18 g/m² or greater, 19 g/m² or greater, 20 g/m² or greater, 21 g/m² or greater, 22 g/m² or greater, 23 g/m² or greater, or 24 g/m² or greater). In some embodiments, the second aqueous-based coating has a coating weight of 25 g/m² or less (e.g., 24 g/m² or less, 23 g/m² or less, 22 g/m² or less, 21 g/m² or less, 20 g/m² or less, 19 g/m² or less, 18 g/m² or less, 17 g/m² or less, 16 g/m² or less, 15 g/m² or less, 14 g/m² or less, 13 g/m² or less, 12 g/m² or less, 11 g/m² or less). In some embodiments, the second aqueous-based coating has a coating weight of from 10 g/m² to 25 g/m² (e.g., 15 g/m² to 23 g/m² or 18 g/m² to 22 g/m²). The coating weight can be reported in units of grams of coating per square meter of paper, and can be calculated directly by the amount of coating applied and the surface area of the paper substrate that the coating is applied to. In some embodiments, the second aqueous-based coating can be applied in an amount of less than 15% by weight based on the weight of the coated paper.

The first coating and/or the second aqueous-based coating can include one or more mineral fillers and/or coating pigments. Mineral fillers generally have a substantial proportion of particles having a particle size greater than 2 microns whereas coating pigments have a substantial proportion of particles having a particle size less than 2 microns. In some embodiments, the mineral fillers and/or coating pigments can be added to impart certain properties to a paper such as smoothness, whiteness, increased density or weight, decreased porosity, increased opacity, flatness, glossiness, and the like. The mineral fillers and/or coating pigments can include calcium carbonate (precipitated or ground), kaolin, clay, talc, diatomaceous earth, mica, barium sulfate, magnesium carbonate, vermiculite, graphite, carbon black, alumina, silicas (fumed or precipitated in powders or dispersions), colloidal silica, silica gel, titanium oxides, aluminum hydroxide, aluminum trihydrate, satine white, and magnesium oxide. The first coating and/or the second aqueous-based coating can include exclusively mineral fillers or coating pigments or can include a blend of mineral fillers and coating pigments (e.g., weight ratios of 90:10, 80:20, 70:30, 60:40, 50:50, 40:60, 30:70, 20:80 or 10:90).

In some embodiments, the first coating and/or second aqueous-based coating can include non-toxic anticorrosive pigments. Examples of such anticorrosive pigments include, but are not limited to, phosphate-type anticorrosive pigments such as zinc phosphate, calcium phosphate, aluminum phosphate, titanium phosphate, silicon phosphate, and ortho- and fused-phosphates thereof.

In some embodiments, the first coating and/or second aqueous-based coating can include one or more dyes and/or colored pigments to produce a colored or patterned paper or to change the shade of the paper. Exemplary dyes can include basic dyes, acid dyes, anionic direct dyes, and cationic direct dyes. Exemplary colored pigments include organic pigments and inorganic pigments in the form of anionic pigment dispersions and cationic pigment dispersions.

The first coating and/or second aqueous-based coating can include additives such as thickeners, dispersants, initiators, stabilizers, chain transfer agents, buffering agents, salts, preservatives, fire retardants, wetting agents, protective colloids, biocides, corrosion inhibitors, crosslinkers, crosslinking promoters, and lubricants. In some embodiments, the first coating and/or second aqueous-based coating can include an additive to prevent depolymerization (e.g., additives to prevent photoinitiation).

The cup can have an interior surface, an exterior surface, a bottom portion, and a side portion. The first coating can be on a first surface of the paper cup. The first surface, in some embodiments, comprises one or more of an interior surface of the side portion or an interior surface of the bottom portion. The second aqueous-based coating can be on a second surface of the paper cup. The second surface, in some embodiments, comprises one or more of an interior surface of the side portion or an interior surface of the bottom portion. The second surface can comprise an interior surface of the bottom portion of the paper cup with the first surface in the interior surface of the side portion. The first surface can comprise an interior surface of the bottom portion of the paper cup with the second surface in the interior surface of the side portion. In some embodiments, the entire interior surface of the bottom portion is coated. In some embodiments, only a portion (e.g., 10% or greater, 20% or greater, 30% or greater, 40% or greater, 50% or greater, 60% or greater, 70% or greater, 80% or greater, 90% or greater, or all) of the interior surface of the bottom portion is coated. In some embodiments, the entire interior surface of the side portion is coated. In some embodiments, only a portion (e.g., 10% or greater, 20% or greater, 30% or greater, 40% or greater, 50% or greater, 60% or greater, 70% or greater, 80% or greater, 90% or greater, or all) of the interior surface of the side portion is coated.

The first surface can be an exterior surface of the bottom portion. The first surface can be an exterior surface of the side portion. The second surface can be an exterior surface of the bottom portion. The second surface can be an exterior surface of the side portion. In some embodiments, the second surface is at least a portion of the exterior of the cup. In some embodiments, the entire exterior surface of the side portion is coated with the first coating, the second aqueous-based coating, or a combination thereof. In some embodiments, only a portion (e.g., 10% or greater, 20% or greater, 30% or greater, 40% or greater, 50% or greater, 60% or greater, 70% or greater, 80% or greater, or 90% or greater) of the exterior surface of the side portion is coated with the first coating, the second aqueous-based coating, or a combination thereof. In some embodiments, the entire exterior surface of the bottom portion is coated with the first coating, the second aqueous-based coating, or a combination thereof. In some embodiments, only a portion (e.g., 10% or greater, 20% or greater, 30% or greater, 40% or greater, 50% or greater, 60% or greater, 70% or greater, 80% or greater, or 90% or greater) of the exterior surface of the bottom portion is coated with the first coating, the second aqueous-based coating, or a combination thereof. In some embodiments, the entire exterior surface of the paper cup is coated with the second aqueous-based coating.

The coating(s) can be added to a paper substrate to form a coated substrate, wherein the coated substrate is then formed into a paper cup. The coating(s) can be added to an already formed paper cup. The paper cup can be formed in any manner known in the art for forming paper cups. In some embodiments, the paper cup is prepared by applying a first coating comprising a polyethylene copolymer onto at least a portion of a surface of a first paper substrate at a temperature above the melting point temperature of the polyethylene copolymer to form a coated paper substrate, wherein the polyethylene copolymer has polar functionality; applying a second aqueous-based coating onto at least a portion of a surface of a second substrate; forming a side wall from one of the first paper substrate and the second paper substrate and bonding the side wall to itself along a side edge; forming a bottom from the other of the first paper substrate and the second paper substrate; and bonding the side wall along a bottom edge to the bottom along a side edge to form the paper cup. The side wall can be bonded to itself along a side edge using the second aqueous-based coating. The bottom portion coated with, for instance, the polyethylene copolymer coating can be brought into contact with the side portion (i.e., side wall) coated with, for instance, an aqueous-based coating, and the side portion of the paper cup can be joined using an induction seal, an impulse seal, a pressure seal, or a combination thereof. In some embodiments, the side portion of the paper can be bonded to itself or to the bottom portion of the paper cup using heat. For example, the coating on the bottom portion and on the side portion can be heated to above the Vicat softening point of the first coating to produce the seal and form the cup. . In some embodiments, the side portion of the paper can be bonded to itself or to the bottom portion of the paper cup without using heat. The cup can be leak-resistant and/or stain-resistant.

The first coating can be used to adhere paper substrates, wherein the first substrate comprises a first coating comprising a polyethylene copolymer and the second paper substrate comprises a second aqueous-based coating dispersion (e.g., a copolymer prepared by polymerizing a vinyl aromatic monomer and an acrylic monomer) by bonding the first coating and the second aqueous-based coating to adhere the first substrate to the second substrate. The first coating can adhere to itself or a surface coated with a first coating. The first coating can adhere to the second aqueous-based coating or a surface coated with the second aqueous-based coating. The first coating can adhere to a non-coated surface.

The coatings can be used on paper cups, including for instance, disposable paper cups. As an alternative to cups, the coatings described herein can be used for coating paper for the production of paper bags for dry foods, such as, for example, coffee, tea, soup powders, sauce powders; for liquids, such as, for example, cosmetics, cleaning agents, beverages; of tube laminates; of paper carrier bags; of paper laminates and coextrudates for ice cream, confectionery (e.g., chocolate bars and muesli bars), of paper adhesive tape; of cardboard cups (e.g., paper cups), yogurt pots, soufflé cups; of meal trays, or meat trays; of wound cardboard containers (e.g., cans, drums), of wet-strength cartons for outer packaging (e.g., wine bottles, food); of fruit boxes of coated cardboard; of fast food plates; of clamp shells; of beverage cartons and cartons for liquids, such as detergents and cleaning agents, frozen food cartons, ice packaging (e.g., ice cups, wrapping material for conical ice cream wafers); of paper labels; or of flower pots and plant pots.

The first coating can impart leak resistance and/or stain-resistance to the paper compared to applications that do not include the first coating. The first coating can impart leak resistance and/or stain-resistance to the paper compared to applications that do not include the first coating. In some embodiments, the first coating and/or the second aqueous-based coating can provide improvements in rheology of the paper coating formulation.

In some embodiments, the first coating is surface-treated. Any surface treatment that increases the surface activity of the polyethylene copolymer, for example, by oxidizing the copolymer, can be used. Exemplary surface treatments include, but are not limited to, corona discharge, plasma discharge, and flame treatment.

The paper cups disclosed herein can be used to hold, for instance, hot liquids like coffee or tea and remain leak-resistant and/or stain-resistant. Coatings that provide a barrier to water, moisture, grease, oil, oxygen etc. must also have the ability to be form a seal and not block during the manufacturing process. For example, paper of paperboard used in a cup that will contain cold or hot liquids must be able to be sealed when the front and back sides of the paper or paperboard are joined and subjected to elevated temperature and pressure and the seal itself must also be resistant to liquid or moisture vapor and maintain its integrity in their presence. For instance, paper cups disclosed herein may exhibit reduced or eliminated leaks from the bottom interface of the paper cups for up to 30 minutes of exposure to hot coffee. For instance, paper cups disclosed herein may exhibit reduced or eliminated staining at the bottom interfaces around the bottom of the paper cups for up to 30 minutes of exposure to hot coffee. Further, the paper cups herein may exhibit minimal tendencies of blocking (i.e., the adhesion of the coated surface to another coated surface, or the adhesion of the coated surface to an uncoated surface) of the extrusion coated paper when wound onto paper rolls, before cutting/forming into bottom portions or side portions of the paper cups. A low degree of adhesion damage to the coated and/or non-coated sides of the roll is desirable. In some embodiments, the paper rolls, when unwound, exhibit layer separation without surface damage to the coated or non-coated side in the roll. Additionally, polyethylene copolymer coatings and/or the coated paper cups disclosed herein can exhibit low seal initiation temperature, minimized capillary leakers, improved secondary sealing with thermal sealing at a high temperature and short residence time, flex crack resistance, and high temperature resistance (to the boiling point of water). Additionally, full FDA clearance for all components, as well as no impartation of organoleptics, is desirable.

Water-resistance of the coatings can be tested with the Cobb method, described by TAPPI T 441 (2001), which is incorporated by reference herein in its entirety. This method determines the amount of water absorbed by paper, paperboard, and corrugated fiberboard in a specified time under standardized conditions and, in some embodiments, the coated substrates described herein would pass the water-resistance test set forth in this test method. Water absorptiveness can be a function of various characteristics of paper or board including, but not limited to, sizing and porosity.

Heat sealing can be evaluated on a Sencorp model 12ASL/1 sealer. The temperature of both the top and bottom jaws can be set, for instance, at 315° C. Coated sheets can be placed face-to-face and sealed at various times and pressures. Pressures can be varied from, for instance, 20 psi to 30 psi to 40 psi. After sealing and cooling to room temperature, the two pieces of board can be pulled apart, and rated on the level of adhesion. Samples can be given a rating of 1 to 5, based on the following scale:
1—No adhesion
2—Adhesion, but no picking or fiber tears
3—Adhesion with coating transfer or slight fiber tear (<5% of surface area)
4—Some fiber tear (5-50%)
5—Fiber tear (>50%)
   Since maximum adhesion at the lowest possible times and pressures is desirable, the rating is 5 to ensure adequate heat seal.

The first coating can have a low seal initiation temperature. The seal initiation temperature can be measured by applying a coating onto 50 lb Kraft paper, measuring a temperature at which 1 lb/in (4.4 N/25.4 mm) heat seal strength is achieved, noting conditions on a Topwave sealer. Additionally, sealing properties can be measured by ASTM F2029 (2008) and Hot Tack Sealing can be measured by ASTM F1921 (2012). Flex Crack Resistance can be measured by ASTM F392 (2011) for plastic films. Further, measuring the pin holes in the coating is important to ensure adequate coating coverage of the paper. Additional test methods and procedures can also be used to determine the improved properties of the coatings and cups disclosed herein.

The paper cups can also be tested using the coffee hold out test, wherein the paper cup (e.g., a standard paper cup of 12 oz.) can be substantially filled with coffee at approximately 90° C. and maintained for at least 30 minutes. The paper cup can then be evaluated visually to look for leakage from the side seams or bottom seam. A paper cup fails this coffee hold out test if any leaking or staining is visible after the 30 minutes has elapsed and is considered leak-resistant (and stain-resistant) if it passes this coffee hold out test.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A paper cup, comprising:
a paper cup having a side portion and a bottom portion,
a first coating comprising a polyethylene copolymer on a first surface of the paper cup, the first surface comprising one or more of an interior surface of the side portion or an interior surface of the bottom portion, wherein the polyethylene copolymer has polar functionality; and
wherein a bottom edge of the side portion is bonded to a side edge of the bottom portion via a seal comprising the first coating.

2. The paper cup of claim 1, wherein the first coating has a thickness of 0.5 mils to 2 mils.

3. The paper cup of claim 1, wherein the first coating has a coating weight of 10 g/m² to 25 g/m².

4. The paper cup of claim 1, wherein the polyethylene copolymer has a melting point temperature of 95° C. to 105° C.

5. The paper cup of claim 1, wherein the polyethylene copolymer has a Vicat softening temperature of 50° C. to 90° C.

6. The paper cup of claim 1, wherein the polyethylene copolymer has a density of 0.65 g/cm³ to 1.1 g/cm³.

7. The paper cup of claim 1, further comprising:
a second aqueous-based coating on a second surface of the paper cup, the second surface comprising an interior surface of the bottom portion of the cup when the first surface is the interior surface of the side portion and the second surface comprising an interior surface of the side portion of the cup when the first surface is the interior surface of the bottom portion,
wherein a bottom edge of the side portion is bonded to a side edge of the bottom portion via a seal comprising the first coating and the second aqueous-based coating.

8. The paper cup of claim 7, wherein the second aqueous-based coating further comprises a pigment that has been treated with a material selected from the group consisting of surfactants; hydrophobically-modified polymers; styrene-acrylic resin emulsions; styrene-butadiene latex emulsions; silanes, siloxanes, siloxane/silicone resin blends, and their carbon-based analogs; and combinations thereof to form a treated pigment.

9. The paper cup of claim 1, wherein the first surface comprises the interior surface of the bottom portion of the paper cup.

10. The paper cup of claim 1, wherein the first surface comprises the interior surface of the side portion of the paper cup.

11. The paper cup of claim 1, wherein the side portion of the paper cup is adhered to itself along a side edge.

12. The paper cup of claim 1, wherein the paper cup does not exhibit a leak along the seal of the paper cup for thirty minutes after substantially filling the cup with hot coffee at a temperature of 90° C.

13. The paper cup of claim 8, wherein the second surface is the inside surface of the side portion, and wherein the treated pigment has been treated with a styrene-acrylic resin emulsion.

14. A method of producing a paper cup, comprising:
forming a side wall or a bottom from a first paper substrate, at least a portion of a surface of the first paper substrate coated with a first coating comprising a polyethylene copolymer, wherein the polyethylene copolymer has polar functionality,
bonding the side wall to itself along a side edge; and
bonding the side wall along a bottom edge to the bottom along a side edge to form a seal comprising the first coating.

15. The method of claim 14, further comprising applying the first coating comprising the polyethylene copolymer onto the at least a portion of the surface of the first paper substrate at a temperature above the melting point temperature of the polyethylene copolymer to form a coated paper substrate.

16. The method of claim 14, wherein the first coating is coated onto the first paper substrate by extrusion coating.

17. The method of claim 14, wherein the first coating is coated onto the first paper substrate at a thickness of 0.5 mils to 2 mils.

18. The method of claim 14, wherein the first coating is coated onto the first paper substrate at a coating weight of 10 g/m² to 25 g/m².

19. The method of claim 14, wherein the polyethylene copolymer has a melting point temperature of greater than 95° C.

20. The method of any one of claim 14, wherein the polyethylene copolymer has a Vicat softening temperature of 50° C. to 90° C.

21. The method of claim 14, wherein the polyethylene copolymer has a density of 0.65 g/cm³ to 1.1 g/cm³.

22. The method of claim 14, further comprising a second paper substrate, wherein at least a portion of the second paper substrate is coated with the polyethylene copolymer and the second paper substrate is formed into a side wall if the first substrate is formed into a bottom and the second paper substrate is formed into a bottom if the first substrate is formed into a side wall.

23. The method of claim 14, further comprising a second paper substrate, wherein at least a portion of the second paper substrate is coated with an aqueous-based coating and the second paper substrate is formed into a side wall if the first substrate is formed into a bottom and the second paper substrate is formed into a bottom if the first substrate is formed into a side wall.

24. The method of claim 23, wherein the aqueous-based coating further comprises a pigment that has been treated with a material selected from the group consisting of surfactants; hydrophobically-modified polymers; styrene-acrylic resin emulsions; styrene-butadiene latex emulsions; and silanes, siloxanes, siloxane/silicone resin blends, and their carbon-based analogs; and combinations thereof.

25. The method of claim 22, wherein the first paper substrate is the bottom and the second paper substrate is the side wall.
